(19) United States
(12) Patent Application Publication
(10) Pub. No.: US 2015/0151677 A1
(43) Pub. Date: Jun. 4, 2015

(54) ILLUMINATED CLEAR SHAFT BENDED POINTER

(71) Applicant: Continental Automotive Systems, Inc., Auburn Hills, MI (US)

(72) Inventors: Vyacheslav Birman, Auburn Hills, MI (US); Christian Jean Tanguy, Rochester, MI (US)

(21) Appl. No.: 14/555,100

(22) Filed: Nov. 26, 2014

Related U.S. Application Data
(60) Provisional application No. 61/910,467, filed on Dec. 2, 2013.

(51) Int. Cl. B60Q 3/04; G01D 13/22

(52) U.S. Cl. CPC B60Q 3/044; G01D 13/22

(57) ABSTRACT

A gauge assembly includes a gauge surface forming a gauge surface curve and a pointer assembly. The pointer assembly includes a pointer having a curved portion that corresponds with the gauge surface curve. The pointer has one or more light reflecting surfaces. The pointer is configured to rotate about an axis of rotation relative to the gauge surface. The light reflecting surface(s) is disposed along the axis of rotation of the pointer, and the light reflecting surface(s) is configured to reflect light through the pointer and against side walls of the pointer.

### CROSS REFERENCE TO RELATED APPLICATIONS

This application claims the benefit of U.S. Provisional Application No. 61/910,467 filed Dec. 2, 2013. The disclosure of the above application is incorporated herein by reference.

### TECHNICAL FIELD

The present disclosure relates to vehicle instrument clusters and gauges, and more specifically a bended pointer for a vehicle cluster and gauge.

### BACKGROUND

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles include instrument panels to communicate information indicative of operation to an operator. Motor vehicles include instrument panels with several gauges and dials that communicate vehicle conditions such as speed, engine rpm, temperature, oil pressure along with many other operational parameters. A pointer is utilized to indicate a current operating parameter on a scale provided on the gauge. In some instances, the shape of the gauge requires a curved or bent shape in the pointer. The shape of a pointer is a consideration when it is desired to maintain substantially uniform pointer illumination during operation.

Accordingly, it is desirable to design and develop an instrument panel that includes a flat panel display with features that add both increased functionality while providing desired three-dimensional appearance and effects.

### SUMMARY

A gauge assembly is provided that propagates light to side surfaces of a pointer, the side surfaces being configured to reflect the light. The pointer has one more reflecting surfaces aligned with the axis of rotation of the pointer.

In one example, a gauge assembly is provided, which may be combined with or separate from other gauge assemblies described herein. The gauge assembly includes a gauge surface forming a gauge surface curve and a pointer assembly. The pointer assembly includes a pointer having a curved portion that corresponds with the gauge surface curve. The pointer has a light reflecting surface. The pointer is configured to rotate about an axis of rotation relative to the gauge surface. The light reflecting surface is disposed along the axis of rotation of the pointer. The light reflecting surface is configured to reflect light through the pointer and against side walls of the pointer.

In another example, which may be separate from or combined with the other examples provided herein, a gauge assembly is provided. The gauge assembly includes a gauge surface forming a gauge surface curve. The gauge assembly also includes a pointer assembly that has a pointer having a curved portion that corresponds with the gauge surface curve. The pointer being configured to rotate about an axis of rotation relative to the gauge surface. The pointer has one or more light reflecting surfaces disposed along the axis of rotation of the pointer. The light reflecting surface(s) is configured to reflect light through the pointer and against side walls of the pointer.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

Examples are reflected in the drawings, which will be described below. The drawings described herein are for illustration purposes only and are not intended to limit the scope of the present disclosure in any way.

FIG. 1 is a schematic view of an example instrument cluster including a gauge assembly, according to the principles of the present disclosure;

FIG. 2 is a cross-sectional view of an example gauge and pointer of the instrument cluster and gauge assembly of FIG. 1, in accordance with the principles of the present disclosure;

FIG. 3 is a perspective view of one variation of the example pointer of FIG. 2, according to the principles of the present disclosure;

FIG. 4 is a perspective view of another variation of the example pointer of FIG. 2, in accordance with the principles of the present disclosure; and

FIG. 5 is a perspective view of yet another variation of the example pointer of FIG. 2, according to the principles of the present disclosure.

### DETAILED DESCRIPTION

The following description is merely exemplary in nature and is not intended to limit the present disclosure, application, or uses.

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

Examples of the invention are described below. It should be noted that these and other examples or embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

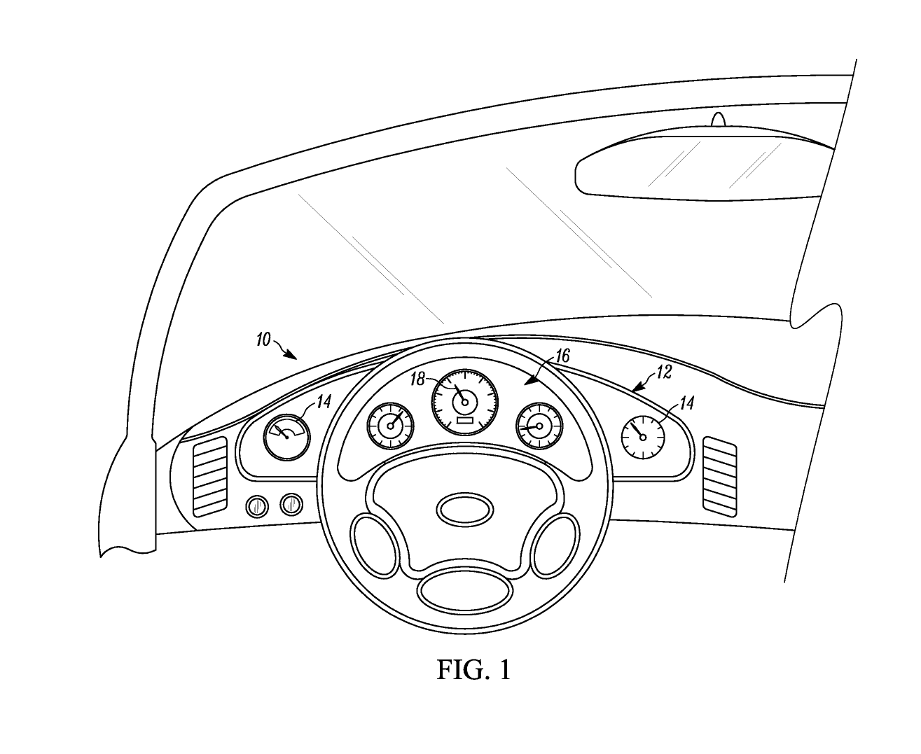

Referring to FIG. 1, a vehicle dashboard 10 is shown and includes an instrument panel 12 that includes a primary gauge assembly 16 and other accessory gauges 14. The example gauge assembly 16 includes a pointer assembly 18 that rotates about an axis A to indicate on defined scale a value indicative of a current vehicle operating parameters.

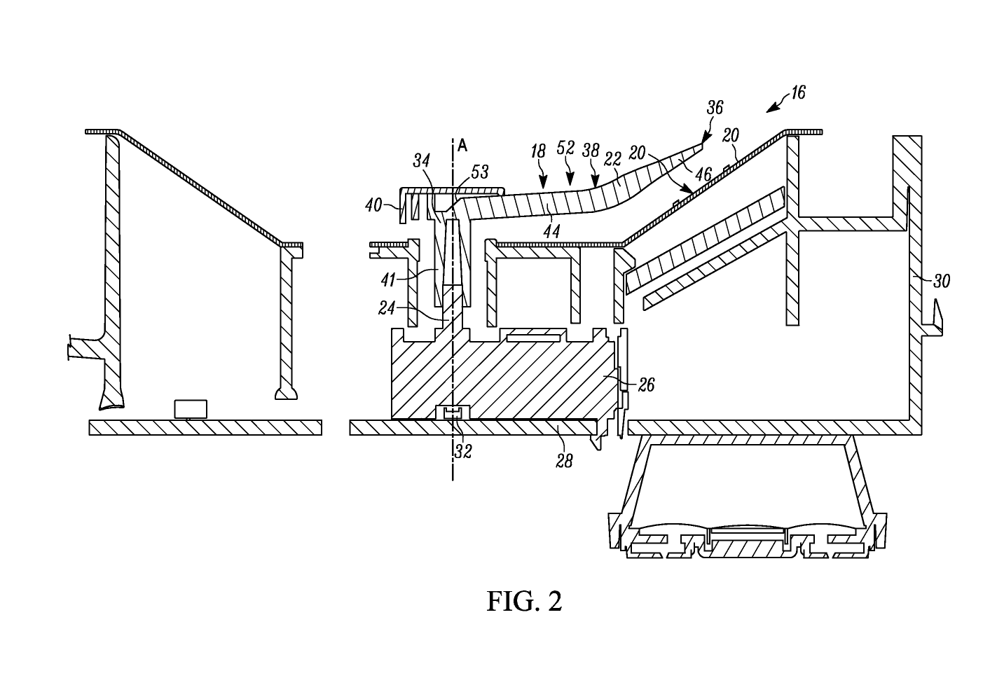

Referring to FIG. 2 with continued reference to FIG. 1, in this example the gauge assembly 16 includes a gauge surface 20 including a scale indicative of a vehicle operating parameter. The example gauge surface 20 is curved upwardly to provide a desired dimensional effect. The pointer assembly 18 is supported about the axis of rotation A proximate to the gauge surface 20. In this example, the pointer assembly 18 includes a pointer 22 that is supported on a shaft 24 of a stepper motor 26. The stepper motor 26 is in turn supported on a printed circuit board 28 supported within a housing 30 of the gauge assembly 16.

The shaft 24 driven by the stepper motor 26 provides for the propagation of light from a light source 32 along the axis A into the pointer 22. The shaft 24 maybe clear or translucent to propagate light into the pointer 22. The shaft 24 may also include a cylindrical opening or bore that provides for the propagation of light along the axis A.

The pointer 22 includes a curved or bent shape that follows and corresponds to the gauge surface 20. The bent gauge surface 20 presents challenges for providing a substantially uniform illumination of the pointer assembly 18. Accordingly, the example pointer 22 includes features for illuminating from a base portion 34 supported along the axis A to the tip portion 36.

The example pointer 22 includes the base portion 34 that includes a hollow shaft 41 received onto the shaft 24 of the stepper motor 26. The shaft 24 in this example is a clear shaft and provides for the propagation of light from the light source 32. The light source 32 is supported on the circuit board 28 and transmits light through the shaft 24 and into the pointer 22 along the axis A.

The pointer assembly 18 includes a cap 40 that is disposed over the pointer 22 along the axis A to prevent bright spots from being visible to a vehicle operator. The pointer 22 includes an arm 52 extending radially outward from the base portion 34 to the tip 36. The arm 52 includes a bend 38 after which the arm 52 extends not only radially outward but upward at an angle corresponding to the gauge surface 20.

The arm 52 includes an initial 44 portion that extends radially outward from the axis A to the bend 38. An outward portion 46 extends from the bend 38 to the tip 36. The outward portion 46 extends at an angle upward that corresponds with an angle of the gauge surface 20.

The light coming through the axis of rotation A and provided by the light source 32 is redirected from the axis A towards the tip 36 of the pointer 22 by a reflecting surface 53. To maintain a substantially uniform illumination of the pointer 22, it is desired to reflect or propagate light off the side surfaces 48 of the pointer 22 rather than the top and bottom surfaces.

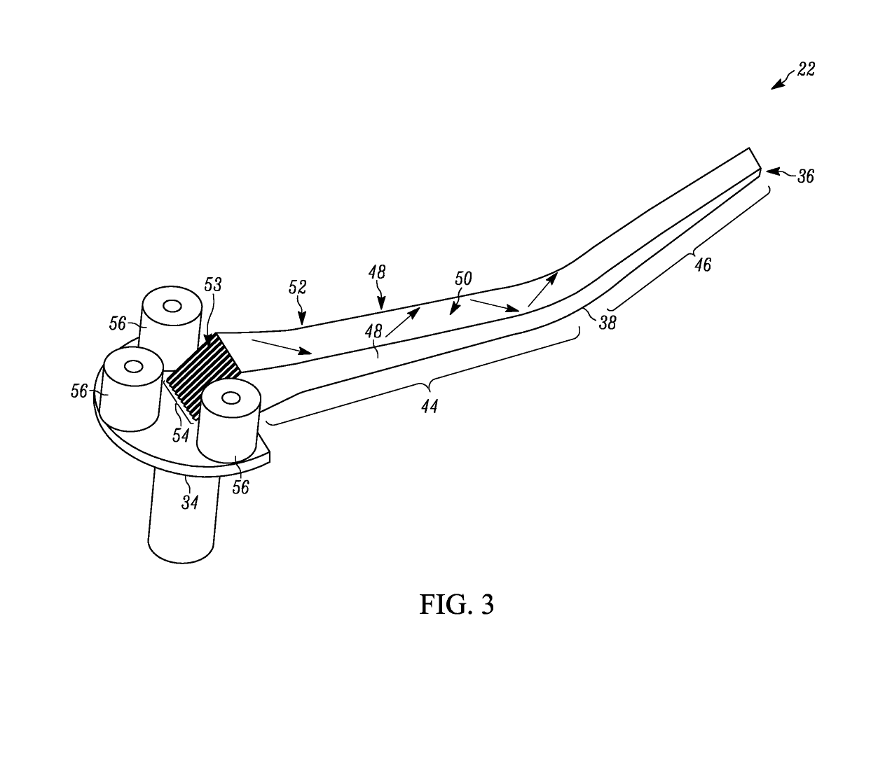

Referring to FIG. 3 with continued reference to FIG. 2, an example pointer 22 includes a reflector surface 53 disposed along the axis A as part of the base portion 34. In this example, the reflecting surface 53 includes a plurality of ribs 54 that direct light transverse relative to the axis A against side walls 48 of the pointer 22. The base 34 includes pin bosses 56 for receiving pins of the cap 40 provided over the reflector surface 53 to prevent bright spots from being visible to a vehicle operator.

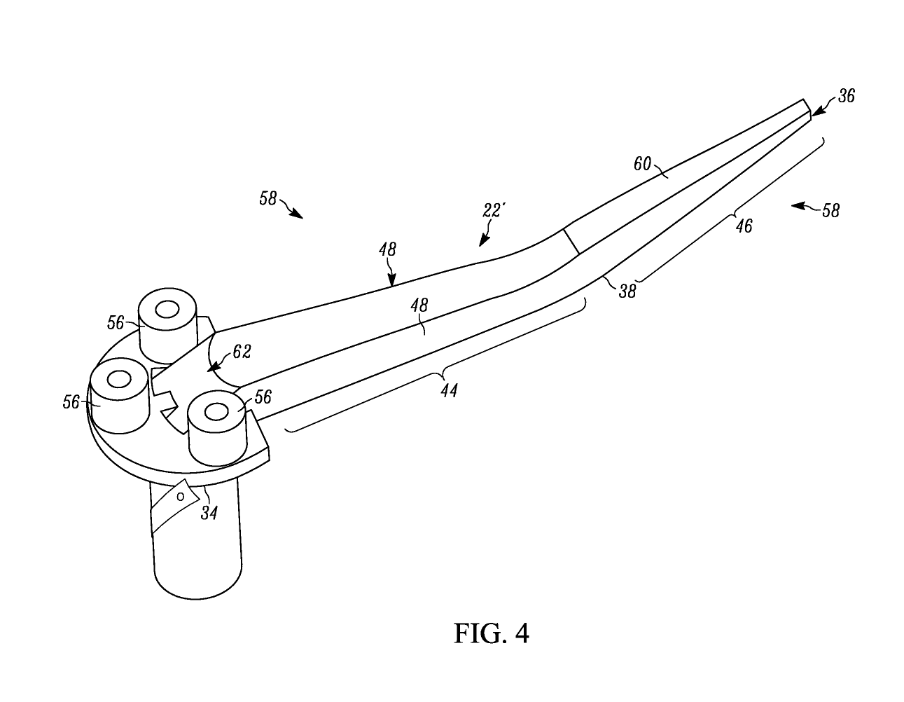

Referring to FIG. 4 with continued reference to FIG. 2, another example pointer assembly 58 includes a reflector surface 62 defining a conical surface disposed along the axis A. The conically shaped reflector surface 62 directs light transverse to the axis A and against the side walls 48 of the pointer 22′ of the pointer assembly 58. The example pointer 22′ further includes a coating 60 on at least the top surface of the outward portion 46. The coating 60 can be applied to provide a color change of the illuminated pointer 22′.

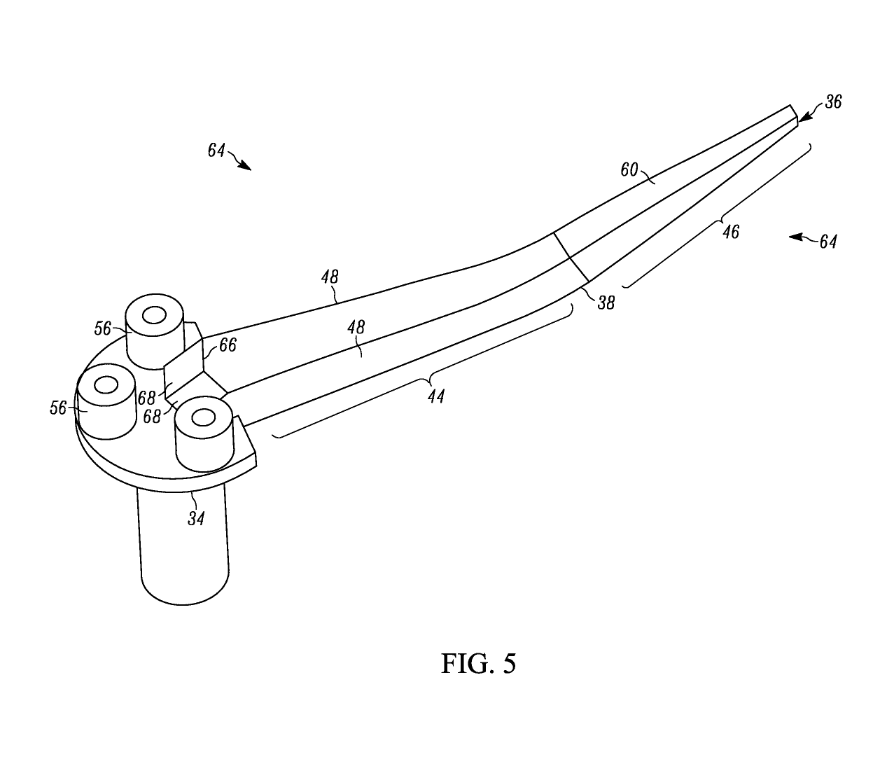

Referring to FIG. 5 with continued reference to FIG. 2, another example pointer 64 is illustrated and includes a reflector surface 66 that includes two flat surfaces 68 that are aligned on the axis A. The flat surfaces 68 are angled relative to the axis A and relative to each other. The flat surfaces 68 propagate light transmitted along the axis A against the side walls 48 to provide the desired uniform illumination of the pointer 64 from the base 34 to the tip portion 36.

Accordingly, the example light reflecting surfaces of the pointer arms provide a substantially uniform illumination from along the pointer arm regardless of a rotational position about the axis that the pointer may be located.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gauge assembly comprising:
a gauge surface forming a gauge surface curve; and
a pointer assembly comprising a pointer having a curved portion that corresponds with the gauge surface curve, the pointer having a light reflecting surface, the pointer being configured to rotate about an axis of rotation relative to the gauge surface, the light reflecting surface being disposed along the axis of rotation of the pointer, the light reflecting surface being configured to reflect light through the pointer and against side walls of the pointer.

2. The gauge assembly of claim 1, wherein the light reflecting surface has a conical shape.

3. The gauge assembly of claim 2, the pointer further comprising a base portion disposed along the axis of rotation and an arm extending radially outward from the base portion, the arm including the curved portion, the side walls being disposed along the arm.

4. The gauge assembly of claim 3, further comprising a light source disposed on the axis of rotation, the light source being configured to provide light to the pointer.

5. The gauge assembly of claim 4, further comprising a stepper motor having a shaft extending therefrom, the shaft being driven by the stepper motor, the pointer being supported on the shaft.

6. The gauge assembly of claim 5, wherein the shaft is one of clear and translucent to propagate the light into the pointer.

7. The gauge assembly of claim 6, wherein the light source is configured to emit light through the shaft, the light being configured to propagate from the shaft to the base portion of the pointer.

8. The gauge assembly of claim 1, wherein the light reflecting surface has a plurality of surface features disposed thereon.

9. The gauge assembly of claim 8, wherein each surface feature of the plurality of surface features is one of a rib and a wave.

10. The gauge assembly of claim 9, the pointer further comprising a base portion disposed along the axis of rotation and an arm extending radially outward from the base portion, the arm including the curved portion, the side walls being disposed along the arm.

11. The gauge assembly of claim 10, further comprising a light source disposed on the axis of rotation, the light source being configured to provide light to the pointer.

12. The gauge assembly of claim 11, further comprising a stepper motor having a shaft extending therefrom, the shaft being driven by the stepper motor, the pointer being supported on the shaft.

13. The gauge assembly of claim 12, wherein the shaft is one of clear and translucent to propagate the light into the pointer.

14. The gauge assembly of claim 13, wherein the light source is configured to emit light through the shaft, the light being configured to propagate from the shaft to the base portion of the pointer.

15. A gauge assembly comprising:
a gauge surface forming a gauge surface curve; and
a pointer assembly comprising a pointer having a curved portion that corresponds with the gauge surface curve, the pointer having at least one light reflecting surface, the pointer being configured to rotate about an axis of rotation relative to the gauge surface, the at least one light reflecting surface being disposed along the axis of rotation of the pointer, the at least one light reflecting surface being configured to reflect light through the pointer and against side walls of the pointer.

16. The gauge assembly of claim 15, wherein the at least one light reflecting surface includes two light reflecting surfaces connected to each other, the two light reflecting surfaces being disposed at angles with respect to each other.

17. The gauge assembly of claim 16, the pointer further comprising a base portion disposed along the axis of rotation and an arm extending radially outward from the base portion, the arm including the curved portion, the side walls being disposed along the arm, the gauge assembly further comprising a light source disposed on the axis of rotation, the light source being configured to provide light to the pointer.

18. The gauge assembly of claim 17, further comprising a stepper motor having a shaft extending therefrom, the shaft being driven by the stepper motor, the pointer being supported on the shaft.

19. The gauge assembly of claim 18, wherein the shaft is one of clear and translucent to propagate the light into the pointer.

20. The gauge assembly of claim 19, wherein the light source is configured to emit light through the shaft, the light being configured to propagate from the shaft to the base portion of the pointer.
